(19) United States
(12) Patent Application Publication
(10) Pub. No.: US 2025/0028091 A1
(43) Pub. Date: Jan. 23, 2025

(54) OPTICAL ELEMENT, OPTICAL SYSTEM, LENS APPARATUS, AND IMAGE PICKUP APPARATUS

(71) Applicant: CANON KABUSHIKI KAISHA, Tokyo (JP)

(72) Inventor: Tomohiko ISHIBASHI, Tochigi (JP)

(21) Appl. No.: 18/757,636

(22) Filed: Jun. 28, 2024

(30) Foreign Application Priority Data
Jul. 19, 2023 (JP) 2023-117319

(51) Int. Cl. G02B 3/08

(52) U.S. Cl. CPC G02B 3/08

(57) ABSTRACT

An optical element comprising a plurality of annulus sections concentrically arranged. The plurality of annulus sections include a first annulus section that includes a plurality of first structures each having a first height, and a plurality of second structures each having a second height different from the first height. The plurality of first structures have mutually different widths in a radial direction. The plurality of second structures have mutually different widths in the radial direction.

### BACKGROUND

### Technical Field

One of the aspects of the embodiments relates to an optical element, an optical system, a lens apparatus, and an image pickup apparatus.

### Description of Related Art

In order to reduce the size of an optical system in an image pickup apparatus, etc., an optical element (metalens) has conventionally been known that has a fine uneven (undulate, relief, or textured) structure formed on the surface of a substrate and provides a light condensing or diverging effect using diffraction. U.S. Patent Application Publication No. 2020/0174163 discloses a metalens formed with a fine uneven structure.

In order to increase the diffraction efficiency (a ratio of a light amount directed toward a specific diffraction angle to an incident light amount) in the optical element having the fine uneven structure, a repetition period (pitch) of the fine uneven structure may be smaller than the wavelength of the incident light. A smooth phase distribution may be realized by changing the shape of the fine uneven structure for each pitch.

However, as the pitch reduces, the aspect ratio of the fine uneven structure increases. Thus, it becomes difficult to form the fine uneven structure and maintain its shape, and the fine uneven structure may be deformed by a slight load, temperature, pressure, or the like.

### SUMMARY

An optical element according to one aspect of the disclosure includes a plurality of annulus sections concentrically arranged. The plurality of annulus sections include a first annulus section that includes a plurality of first structures each having a first height, and a plurality of second structures each having a second height different from the first height. The plurality of first structures have mutually different widths in a radial direction. The plurality of second structures have mutually different widths in the radial direction.

Further features of various embodiments of the disclosure will become apparent from the following description of embodiments with reference to the attached drawings.

### BRIEF DESCRIPTION OF THE DRAWINGS

FIGS. 1A, 1B, and 1C are configuration diagrams of an optical element according to each example.

FIG. 2 is a configuration diagram of an optical element according to a comparative example.

FIG. 3 illustrates a relationship between the shape of an uneven element of the optical element and a phase modulation amount in each example.

FIG. 4 illustrates a relationship between the shape of an uneven element of the optical element and a phase modulation amount in the comparative example.

FIGS. 5A, 5B, and 5C explain a method for manufacturing the optical element according to each example.

FIG. 6 explains an offset layer according to each example.

FIG. 7 explains a modulation amount of a normalized phase in a radial direction of the optical element according to each example.

FIG. 8 explains a width of the uneven element in the radial direction of each of the optical elements according to each example and comparative example.

FIGS. 9A and 9B explain an element filling rate according to each example.

FIG. 10 is a configuration diagram of an optical element according to Example 16.

FIG. 11 is configuration diagram of an optical element according to Example 17.

FIGS. 12A and 12B are configuration diagrams of an optical element according to Example 18.

FIG. 13 explains an optical system including the optical element according to any one of the above examples.

FIG. 14 explains an image pickup apparatus having the optical element according to any one of the above examples.

### DESCRIPTION OF THE EMBODIMENTS

Referring now to the accompanying drawings, a detailed description will be given of embodiments according to the disclosure.

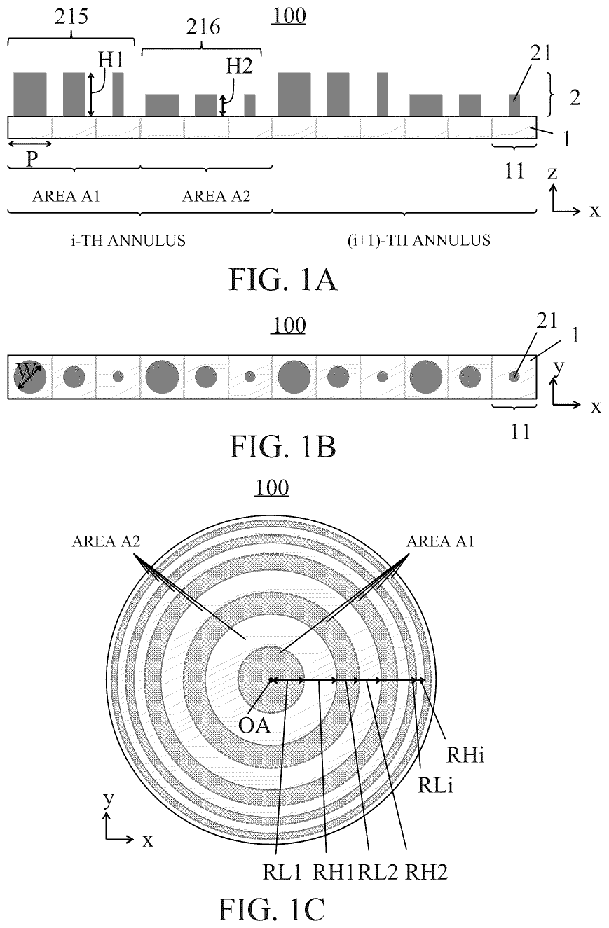

Referring now to FIGS. 1A, 1B, and 1C, a description will be given of the optical element 100 according to each example. FIGS. 1A, 1B, and 1C are configuration diagrams of the optical element 100. FIG. 1A is an enlarged sectional view of the optical element 100 (on an xz plane) viewed from a y-axis direction. FIG. 1B is an enlarged top view of the optical element 100 (on an xy plane) viewed from a z-axis direction (optical axis direction). FIG. 1C is an overall top view of the optical element 100 (on the xy plane) viewed from the z-axis direction (optical axis direction). In each example, the optical axis direction of the optical element 100 and the thickness direction of the substrate 1 accord with the z-axis direction.

The optical element 100 according to each example includes a substrate 1 and an uneven structure (pillars) 2 formed on the substrate 1. The uneven structure 2 includes a plurality of uneven elements (a plurality of structures) including at least one of concave portions or convex portions periodically arranged in the radial direction. Forming a periodic phase difference (annulus sections or annuli) in the radial direction of the substrate 1 can provide the incident light with a condensing or diverging effect. The optical element 100 includes a plurality of annulus sections that include a first annulus section (i-th annulus section or annulus) and a second annulus section ((i+1)-th annulus section or annulus) disposed along the radial direction so as to extend in the circumferential direction with respect to the center of the optical element 100. Each of the plurality of annulus sections has an area A1 (first area) and an area A2 (second area) disposed along the radial direction of the optical element 100. In each example, at least one of the plurality of annulus sections may have the areas A1 and A2, but the plurality of annulus sections may have the areas A1 and A2, and all the annulus sections may have the areas A1 and A2.

The plurality of uneven elements (the plurality of structures) 21 have a plurality of first structures 215 disposed in the areas A1 and a plurality of second structures 216 disposed in the areas A2. H1 is a height (first height) of each of the plurality of first structures 215, and H2 is a height (second height) of each of the plurality of second structures 216. The heights H1 and H2 are different from each other. The heights H1 of the plurality of first structures 215 do not have to be the same, and may be partially different from each other. This is similarly applicable to the heights H2 of the plurality of second structures 216. The plurality of first structures 215 have different widths in the radial direction. Similarly, the plurality of second structures 216 have different widths in the radial direction. However, all of the widths of the plurality of first structures 215 do not need to be different, and some of them may be the same. This is similarly applicable to the widths of the plurality of second structures 216.

The substrate 1 is a transparent flat plate made of synthetic quartz. The substrate 1 may be a plane mirror that reflects incident light, or may be a curved surface having an arbitrary curvature. The material of the substrate 1 is not limited to synthetic quartz, and may be inorganic glass, organic materials such as plastics, ceramics, metals, etc. The uneven structure 2 is formed on the surface of the substrate 1, and provides a phase difference to the light passing through the uneven structure 2, thereby giving a light condensing or diverging effect. Each example obtains a light condensing effect almost equivalent to that of a diffractive optical element by forming a phase distribution by the annulus sections in which a phase difference of 2nπ(n=1, 2, . . . , an integer representing a designed diffraction order or a diffraction order) concentrically and periodically repeats.

The uneven structure 2 has uneven elements 21. The uneven elements 21 consist of periodically arranged concave or convex portions. In each example, the uneven elements 21 consist of convex cylindrical elements made of a dielectric material Si₃N₄. The shape of the uneven element 21 is not limited to a convex cylindrical element, but may be a polygonal column, a polygonal pyramid, a cone, an arbitrary concave element, or a combination thereof. The material of the uneven elements 21 may be TiO₂, GaN, GaP, GaAs, Si, SiC, Al₂O₃, SiO₂, or the like.

The uneven element 21 is a convex cylindrical element disposed at the center of a unit division segment 11 divided into squares in the radial direction of the substrate 1. Due to the width (pitch) of the segments 11 smaller than the wavelength of the incident light, the light is effectively phase-modulated according to the effective refractive index required from a filling rate (element filling rate) that occupies a unit division (segment) regardless of the shape of the uneven element 21. For example, in a case where the incident light is in the visible light range (400 to 700 nm), the pitch (array period) P [nm] may be less than 400 nm, and the pitch P may be further reduced because unnecessary diffracted light can be suppressed. The i-th annulus section (i=1, 2, . . . ) has an area A1 having the plurality of uneven elements 21 with the height H1 and the substrate 1 and an area A2 having the plurality of uneven elements 21 with the height H2.

In each example, the convex elements of the uneven elements 21 in the areas A1 and A2 are made of the same materials of Si₃N₄. Each of the areas A1 and A2 in the i-th annulus section has a plurality of uneven elements 21, and each shape has a different width in the radial direction of the substrate 1. Thereby, a phase distribution of 2mπ in the annulus section is formed. Although the top view of FIG. 1B is a schematic diagram illustrating the segments 11 one-dimensionally arranged, the segments 11 may be two-dimensionally arranged to obtain the light condensing and diverging effects. In the direction orthogonal to the optical axis, RLi and RHi are radii of the areas A1 and A2 in the i-th annulus section from the optical axis, respectively. As understood from FIG. 1C, the areas A1 and A2 are alternately arranged concentrically in the direction orthogonal to the optical axis so that RLi<RHi.

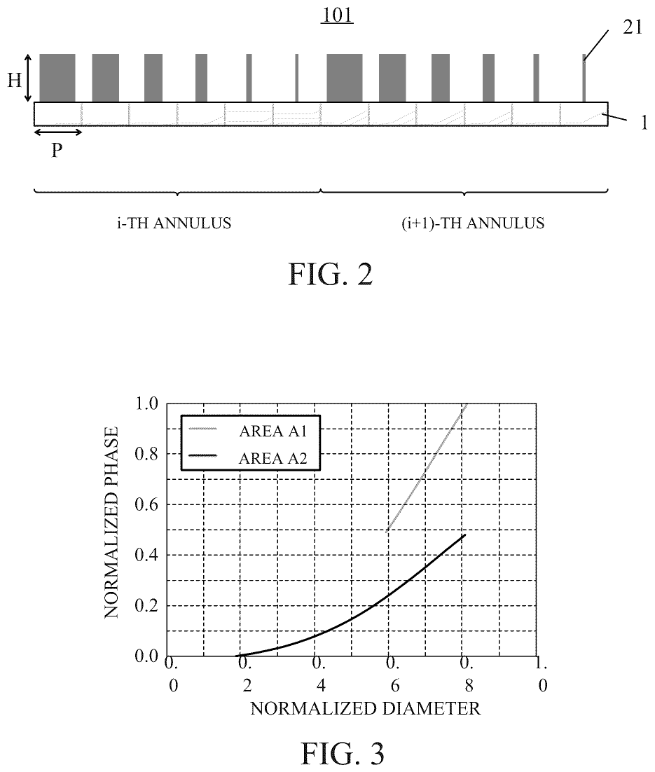

Referring now to FIG. 2, a description will be given of an optical element 101 in which the uneven elements 21 have the constant height H in the entire area according to a comparative example. FIG. 2 is a configuration diagram of the optical element 101 according to the comparative example. In order to form a phase distribution of 2nπ within the annulus section, the width (diameter) of the convex cylindrical element as the uneven element 21 is changed and the element filling rate of the uneven element 21 within the segment is changed. That is, the element filling rate decreases in order from a convex cylindrical element having a large diameter to a convex cylindrical element having a small diameter, and a desired phase distribution is formed. In the optical element 101 illustrated in FIG. 2, the element filling rate is adjusted only by the diameter of the convex cylindrical element, so the diameter is significantly changed. Therefore, the minimum diameter of the convex cylindrical element tends to decrease, and the aspect ratio (the ratio of the height to the width of the uneven element 21 (height/width)) tends to increase. For a relatively elongate element with a large aspect ratio, the shape may deform, tilt, or peel off in a case where a load is applied due to contact or vibration, or in a case where an external factor such as temperature or pressure changes. Accordingly, each example forms the uneven structure 2 without increasing the aspect ratio by reducing the heights of the uneven elements in the area A2 where a phase modulation amount is relatively small.

FIG. 3 illustrates a relationship between the shape of the uneven element 21 of the optical element 100 and the phase modulation amount according to each example, and relates to the diameter of the convex cylindrical element that is the uneven element 21 and the phase modulation amount. In FIG. 3, the horizontal axis represents a diameter W of the convex cylindrical element (normalized diameter normalized by the pitch P of the segment), and the vertical axis represents a normalized phase obtained by normalizing a phase modulation amount by 2mπ (where a diffraction order m is 1). In a case where the normalized phase is in a range from 0 to 0.488, the normalized diameter of the convex cylindrical element in the area A2 changes from 0.187 to 0.813. In a case where the normalized phase is in a range from 0.488 to 1, the normalized diameter of the convex cylindrical element in the area A1 changes from 0.592 to 0.813. Thereby, a phase modulation amount of the normalized phase 0 to 1 can be obtained. The maximum value AR1 of the aspect ratio of the plurality of structures 215 in the area A1 is 6.2, and the maximum value AR2 of the aspect ratio of the plurality of structures 216 in the area A2 is 9.8.

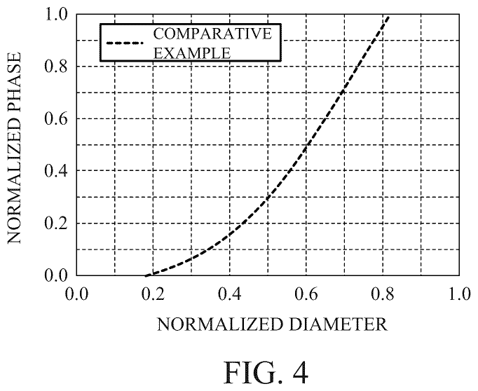

FIG. 4 illustrates a relationship between the shape of the uneven element 21 and a phase modulation amount of the optical element 101 according to the comparative example, and relates to the diameter of the convex cylindrical element and the phase modulation amount in the optical element 101. At this time, in order to obtain a phase modulation amount of the normalized phase 0 to 1, the normalized diameter is to change from 0.181 to 0.819, and the maximum value of the aspect ratio is 20.2, which is larger than that in a case where the height of the uneven element 21 changes for each area. It is thereby understood that changing the height of the uneven element 21 can suppress the aspect ratio of the uneven element 21.

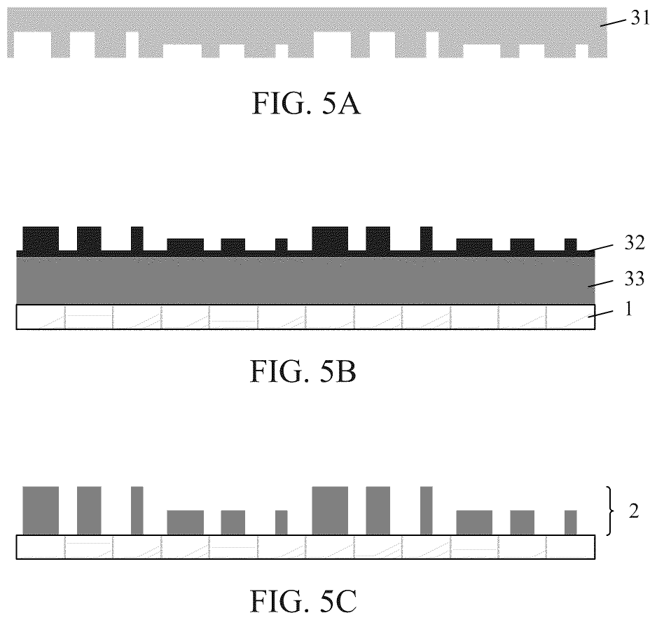

Referring now to FIGS. 5A, 5B, and 5C, a description will be given of a method for manufacturing the optical element 100 according to each example. The optical element 100 can be manufactured using lithography technology. FIGS. 5A, 5B, and 5C explain a method for manufacturing the optical element 100, and illustrate the step for manufacturing the optical element 100 using nanoimprint lithography. FIG. 5A illustrates a mold 31, which has a shape that is an inversion of the uneven shape of the uneven element 21 formed by an electron beam, a laser, or the like. As illustrated in FIG. 5B, a resist material 32 is applied to a film 33 deposited on the substrate 1, the mold 31 is pressed, and ultraviolet rays or the like are irradiated, so that an inverted shape of the uneven shape of the mold 31 is formed on the resist material 32. Thereafter, as illustrated in FIG. 5C, the mold 31 is peeled off and developed so that the uneven shape of the resist material 32 is transferred to the film 33, and thereby the uneven structure 2 is formed on the substrate 1 of the optical element 100. In each example, the method for manufacturing the uneven structure 2 is not limited to nanoimprint lithography, and another method may be used, such as directly forming the uneven structure 2 using an electron beam, a laser, or the like.

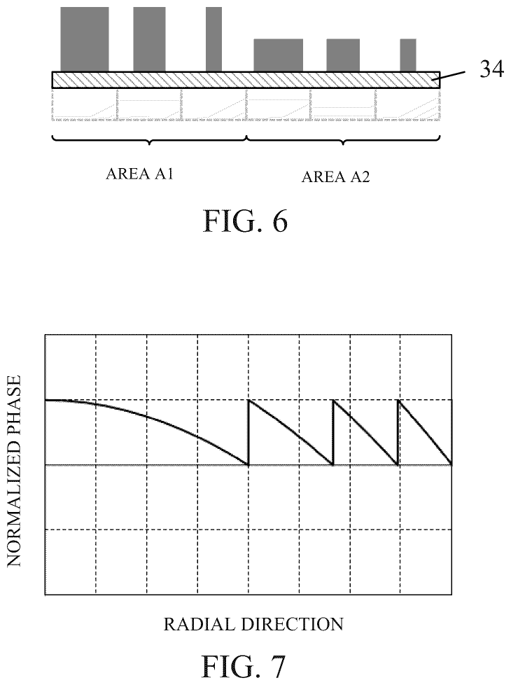

FIG. 6 explains an offset layer 34 according to each example. As illustrated in FIG. 6, instead of a structure in which the uneven structure 2 is directly formed on the substrate 1 as illustrated in FIG. 5C, the offset layer 34 disposed crossing the areas A1 and A2 may be provided. The substrate 1 may include the offset layer 34 and be treated as the substrate 1.

Now assume that H1 is a height of each of the uneven elements 21 in the area A1 (height of each of the plurality of first structures 215), and H2 is a height of each of the uneven elements 21 in the area A2 (height of each of the plurality of second structures 216). Wmax1 is a maximum width of the uneven element 21 in the area A1 (maximum width of the plurality of first structures 215, the width of the leftmost convex element in the area A1 in FIG. 1A), and Wmax2 is a maximum width of the uneven element 21 in the area A2 (maximum width of the plurality of second structures 216, the width of the leftmost convex element in the area A2 in FIG. 1A). Wmin1 is a minimum width of the uneven element 21 in the area A1 (minimum width of the plurality of first structures 215, the width of the rightmost convex element in the area A1 in FIG. 1A), and Wmin2 is a minimum width of the uneven element 21 in the area A2 (minimum width of the plurality of second structures 216, the width of the rightmost convex element in the area A2 in FIG. 1A). At this time, the following inequalities (1) to (3) may be satisfied in each example:

$$0.05 \leq H 2 / H 1 \leq 0.95 \qquad ( 1 )$$

$$1. < W max 1 / W min 1 < 20. \qquad ( 2 )$$

$$1. < W max 2 / W min 2 < 20.00 \qquad ( 3 )$$

Inequality (1) relates to the shape of the uneven element 21. Due to the height H2 of the uneven element 21 in the area A2 where a phase modulation amount is relatively small, which is lower than the height H1 of the uneven element 21 in the area A1, a desired phase modulation amount can be obtained while a shape can be realized with a reduced aspect ratio of the uneven element 21.

In a case where the value becomes lower than the lower limit of inequality (1), the height H2 of the uneven element 21 in the area A2 becomes relatively low, and the phase modulation amount cannot be increased in a case where the width of the uneven element 21 in the area A2 changes. At this time, in order to obtain the desired phase modulation amount, the width of the uneven elements 21 in the area A2 is to relatively significantly change, so that the effect of reducing the aspect ratio in the area A2 cannot be obtained. In each example, the lower limit of inequality (1) may be changed to 0.10, 0.15, 0.20, 0.24, 0.28, 0.32, 0.34, or 0.36.

On the other hand, in a case where the value becomes higher than the upper limit of inequality (1), the height H2 of the uneven element 21 in the area A2 becomes relatively high and in order to obtain the desired phase modulation amount, the width of the uneven elements 21 in the area A2 is to relatively reduce and thus the effect of reducing the aspect ratio in the area A2 cannot be obtained. In each example, the upper limit of inequality (1) may be changed to 0.90, 0.85, 0.80, 0.76, 0.72, 0.70, 0.68, 0.66, 0.64, 0.62, or 0.60.

In a case where the uneven element 21 has a cylindrical shape, the diameter of the circle can be used as the width of the uneven element as illustrated in FIG. 1B. The width of the uneven element 21 may be a length of a side in a case where the uneven element 21 has a quadrangular prism element, or a converted diameter of a cylindrical element that provides an equivalent phase modulation amount in a case where the uneven element 21 has a complex shape.

Inequalities (2) and (3) relate to the shape of the uneven element 21. In the areas A1 and A2, changing the width of the uneven element 21 within a predetermined range can provide a desired phase modulation amount.

Inequalities (2) and (3) normalize the maximum width of the uneven elements 21 with the minimum width of the uneven elements 21, and thus the values never become lower than the lower limits of inequalities (2) and (3), but a desired phase modulation amount can be easily acquired by increasing the values to a certain extent. In each example, the lower limits of inequalities (2) and (3) may be changed to 1.04, 1.08, 1.12, 0.14, 1.18, 1.22, 1.24 or 1.26. In a case where the values become higher than the upper limits of inequalities (2) and (3), the width of the uneven element 21 becomes relatively small, and an aspect ratio increases. In each example, the upper limits of inequalities (2) and (3) may be changed to 18.00, 16.00, 14.00, 12.00, 10.00, 8.00, 7.00, 6.00, or 5.00.

In a case where the height of the uneven elements 21 has a slight undulation in the radial direction of the substrate, an average value of the heights of the uneven elements in the annulus section may satisfy inequality (1). In addition, inequalities (1) to (3) may not be satisfied in areas where the effects of each example are not expected, such as an unintended local uneven portion due to manufacturing errors or a structure outside a ray effective portion.

In each example, in a case where each of the plurality of structures includes concave elements, each structure refers to a structure that includes side surfaces and a bottom surface that form the space of the concave portion. In this case, the height of the structure is a height of the concave portion, and the width of the structure is a width of the concave portion.

Now assume that P is a repetitive period of the uneven elements (the array period of uneven elements that are unit elements of a plurality of structures: pitch). ΔW1 is a difference between the maximum width and the minimum width of the uneven elements 21 in the area A1 (difference between the maximum width and the minimum width of the plurality of first structures 215), and ΔW2 is a difference between the maximum width and the minimum width of the uneven elements 21 in the area A2 (difference between the maximum width and the minimum width of the plurality of second structures 216). At this time, in each example, the following inequalities (4) and (5) may be satisfied.

$$0.05 \leq Δ W 1 / P \leq 0 \text{.80} \qquad ( 4 )$$

$$0.15 \leq Δ W 2 / P \leq 0.95 \qquad ( 5 )$$

Inequalities (4) and (5) relate to the shape of the uneven element 21 in the radial direction. Satisfying inequalities (4) and (5) can suppress a width change amount of the uneven element 21, and realize a shape with a reduced aspect ratio of the uneven element 21. In a case where the values become lower than the lower limits of inequalities (4) and (5), a phase modulation amount obtained by a slight change in the width of the uneven element 21 may significantly change, and it becomes difficult to stably manufacture an optical element with the desired performance. In a case where the values become higher than the upper limits of inequalities (4) and (5), the width of the uneven elements 21 reduces, the aspect ratio increases, a distance between adjacent uneven elements reduces, and manufacturing becomes difficult.

In order to further secure the effects of each example, the lower limit of inequality (4) may be changed to 0.06, 0.07, 0.08, 0.09, 0.10, 0.11, 0.12, 0.13, 0.14 or 0.15. The upper limit of inequality (4) may be changed to 0.76, 0.72, 0.68, 0.64, 0.62, or 0.60. The lower limit of inequality (5) may be changed to 0.16, 0.17, 0.18, 0.20, 0.22, 0.24, or 0.26. The upper limit of inequality (5) may be changed to 0.90, 0.86, 0.82, 0.78, 0.74, 0.72, or 0.70.

In each example, the following inequality (6) may be satisfied:

$$0.05 \leq Δ W 1 / Δ W 2 \leq 1.5 \qquad ( 6 )$$

Inequality (6) relates to a relationship between the shapes of the uneven elements 21 in the areas A1 and A2. Satisfying inequality (6) can realize a shape in which the aspect ratio of the uneven elements in the area A2 is particularly reduced. In a case where the value becomes lower than the lower limit of inequality (6), a phase modulation amount obtained by a slight change in the width of the uneven element 21 in the area A1 significantly changes and it becomes difficult to stably manufacture an optical element with the desired performance. On the other hand, in a case where the value becomes higher than the upper limit of inequality (6), a width change amount of the uneven elements 21 in the area A1 becomes relatively large, and an aspect ratio increases. In order to further secure the effects of each example, the lower limit of inequality (6) may be changed to 0.10, 0.14, 0.18, 0.22, 0.24 or 0.25. The upper limit of inequality (6) may be changed to 1.45, 1.40, 1.35, 1.30, 1.25, or 1.20.

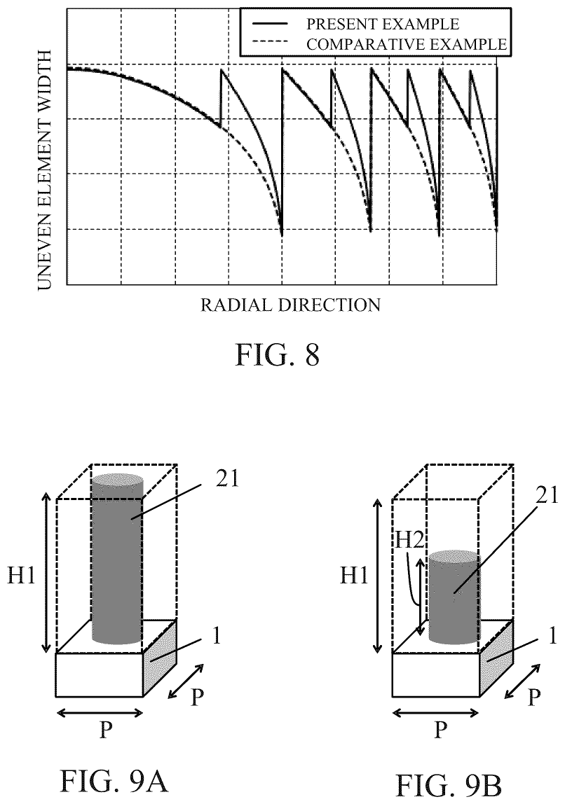

Regarding light traveling in the thickness direction of the substrate 1, a phase modulation amount (the phase delay amount) caused by the uneven structure 2 may be larger in the area A1 than that in the area A2. FIG. 7 explains a modulation amount of a normalized phase in the radial direction of the substrate 1. In FIG. 7, the vertical axis represents a normalized phase, and the horizontal axis represents a position in the radial direction. FIG. 8 explains an uneven element width (for example, the diameter of a convex cylindrical element, etc.). In FIG. 8, the vertical axis represents an uneven element width, and the horizontal axis represents a position in the radial direction. In FIG. 8, the structure of the optical element 100 according to each example is illustrated by a solid line, and the structure of the optical element 101 according to the comparative example having an uneven structure with a constant height is illustrated by a dotted line.

Each example makes the height of the uneven elements in the area A1 higher than that in the area A2 to increase a phase modulation amount, changes an uneven element width in each area, makes a change amount of the uneven element width smaller than that in the comparative example, and thereby suppresses the aspect ratios of the uneven elements in the areas A1 and A2. In a case where the phase modulation caused by the uneven structure in the area A1 is smaller than that in the area A2, a desired phase distribution cannot be obtained unless the change amounts in the uneven element widths in the areas A1 and A2 are relatively large and the effect of suppressing the aspect ratios cannot be obtained.

Referring now to FIGS. 9A and 9B, a description will be given of an element filling rate. FIGS. 9A and 9B explain the element filling rate. FIG. 9A illustrates the element filling rate in the area A1 where the uneven elements 21 with the height H1 are disposed, and FIG. 9B illustrates the element filling rate in the area A2 where the uneven elements 21 with the height H2 are disposed.

The element filling rate is a ratio of a volume occupied by the uneven element per segment. As illustrated in FIGS. 9A and 9B, the element filling rate in the areas A1 and A2 is a volume ratio of the uneven elements 21 to a volume Va defined by a bottom surface P×P times a height H1. Assume that V1min is a minimum value of the element filling rates of the uneven elements in the area A1, and V2max is a maximum value of the element filling rates of the uneven elements in the area A2, relative to the repetitive period P and the height H1 of the uneven element in the area A1. Then, the following inequality (7) may be satisfied:

$$0.7 \leq V 2 max / V 1 min \leq 1.5 \qquad ( 7 )$$

Inequality (7) relates to the shapes of the uneven elements in the areas A1 and A2. Satisfying inequality (7) can realize a shape with a reduced aspect ratio of the uneven element. In a case where the value becomes lower than the lower limit of inequality (7), a minimum width of the uneven structure in the area A1 reduces and an aspect ratio increases. On the other hand, in a case where the value becomes higher than the upper limit of inequality (7), a maximum width of the uneven structure in the area A2 increases, a distance between the uneven elements reduces, and manufacturing becomes difficult. In order to further secure the effect of each example, the lower limit of inequality (7) may be changed to 0.74, 0.76, 0.78, 0.79, 0.80, 0.81 or 0.82. The upper limit of inequality (7) may be changed to 1.45, 1.40, 1.35, 1.30, 1.25, or 1.20.

The following inequalities (8) to (10) may be satisfied:

$$1.5 \leq A R 1 \leq 20.00 \qquad ( 8 )$$

$$1.5 \leq A R 2 \leq 20 \text{.00} \qquad ( 9 )$$

$$0.5 \leq AR 2 / AR 1 \leq 4.00 \qquad ( 10 )$$

where AR1 is a maximum value of the aspect ratio of the uneven elements in the area A1 and AR2 is a maximum value of the aspect ratio of the uneven elements in the area A2.

Inequalities (8) and (9) relate to the shapes of the uneven elements in the areas A1 and A2. In a case where the values become lower than the lower limits of inequalities (8) and (9), a phase modulation becomes relatively large due to a slight change in the uneven element width, the influence of manufacturing variations increases in forming the uneven structure, and manufacturing becomes difficult. On the other hand, in a case where the values become higher than the upper limits of inequalities (8) and (9), an aspect ratio increases and the structure is likely to collapse due to external factors. In order to further secure the effects of each example, the lower limits of inequalities (8) and (9) may be changed to 2.00, 3.00, 3.40, 3.80, 4.00, 4.20, 4.40, 4.60, 4.80, 5.00, or 5.20. The upper limits of inequalities (8) and (9) may be changed to 18.00, 16.00, 15.00, 14.00, 13.00, 12.00, 11.00, 10.00, 9.00 or 8.00.

Inequality (10) relates to the shape of the uneven element. In a case where the value becomes lower than the lower limit of inequality (10), a change amount of the uneven element width becomes large in the area A1, and the effect of suppressing the aspect ratio in the area A1 cannot be obtained. In a case where the value becomes higher than the upper limit of inequality (10), a change amount of the uneven element width increases in the area A2, and the effect of suppressing the aspect ratio in the area A2 cannot be obtained. In order to further secure the effect of each example, the lower limit of inequality (10) may be changed to 0.60, 0.80, 1.00, 1.20, 1.40, 1.60, 1.80, 1.90 or 2.00. The upper limit of inequality (10) may be changed to 3.80, 3.60, 3.40, 3.20, 3.00, 2.80, 2.60, 2.50, or 2.40.

In each example, the maximum widths Wmax1Wmax2 of the uneven elements in the areas A1 and A2 may satisfy the following inequality (11):

$$0.6 \leq W max 2 / W max 1 \leq 1.2 \qquad ( 11 )$$

Inequality (11) relates to the shapes of the uneven elements. In a case where the value becomes lower than the lower limit of inequality (11), an uneven element width in the area A2 becomes relatively small, and an aspect ratio is to increase in order to obtain a desired phase difference. On the other hand, in a case where the value becomes higher than the upper limit of inequality (11), an uneven element width in the area A1 becomes relatively small, and an aspect ratio is to increase in order to obtain a desired phase difference. In order to further secure the effects of each example, the lower limit of inequality (11) may be changed to 0.60, 0.65, 0.70, 0.75, 0.80, 0.82, 0.84, 0.86, 0.88, 0.90, 0.92, 0.94 or 0.95. The upper limit of inequality (11) may be changed to 1.18, 1.16, 1.14, 1.12, 1.10, 1.08, 1.06, or 1.05.

In the optical element according to each example, the phase distribution depends on the reference wavelength λ0. The following inequality (12) may be satisfied:

$$0.25 \leq Δ H / m / λ0 \leq 3. \qquad ( 12 )$$

where ΔH is a difference in height between the uneven elements in the areas A1 and A2, and m is a diffraction order.

Inequality (12) relates to the shapes of the uneven elements. The phase distribution determines the annulus sections based on a phase relative to a reference wavelength λ0. In a case where the value becomes lower than the lower limit of inequality (12), a difference in a phase modulation amount obtained in the areas A1 and A2 reduces, so it is difficult to obtain a desired phase difference unless a change amount in the uneven element width in each area is increased, and thus the effect of suppressing the aspect ratio cannot be obtained. On the other hand, in a case where the value becomes higher than the upper limit of inequality (12), an aspect ratio increases and the structure easily collapses due to external factors. In order to further secure the effects of each example, the lower limit of inequality (12) may be changed to 0.30, 0.35, 0.40, 0.45, 0.50, 0.60, 0.65, 0.70 or 0.75. The upper limit of inequality (12) may be changed to 2.50, 2.00, 1.80, 1.60, 1.40, 1.30 or 1.20.

In each example, the following inequalities (13) and (14) may be satisfied:

$$0.15 \leq N P \leq 0.85 \qquad ( 13 )$$

$$0.5 \leq NP / H 2 \times H 1 \leq 1.5 \qquad ( 14 )$$

where NP is a ratio of a minimum phase in the area A1 to a maximum phase difference in the annulus section.

Inequality (13) relates to a phase modulation amount at the boundary between the areas A1 and A2. In a case where the value becomes lower than the lower limit of inequality (13), a change amount in the uneven element width increases in the area A1, and the effect of suppressing the aspect ratio in the area A1 cannot be obtained. On the other hand, in a case where the value becomes higher than the upper limit of inequality (13), a change amount in the uneven element width increases in the area A2, and the effect of suppressing the aspect ratio in the area A2 cannot be obtained. In order to further secure the effects of each example, the lower limit of inequality (13) may be changed to 0.18, 0.20, 0.22, 0.24, 0.28, 0.32, 0.34, 0.36, 0.38, or 0.40. The upper limit of inequality (13) may be changed to 0.80, 0.75, 0.70, 0.65, or 0.60.

Inequality (14) relates to a phase modulation amount and the shape of the uneven element at the boundary between the areas A1 and A2. By setting the ratio NP of the minimum phase in the area A1 to the maximum phase difference in the annulus section according to the heights of the uneven elements in the areas A1 and A2, the effect of suppressing the aspect ratio of the uneven element can be more effectively obtained. In a case where the value becomes lower than the lower limit of inequality (14), a change amount of the uneven element width increases in the area A1, and the effect of suppressing the aspect ratio in the area A1 cannot be obtained. On the other hand, in a case where the value becomes higher than the upper limit of inequality (14), a change amount in the uneven element width increases in the area A2, and the effect of suppressing the aspect ratio in the area A2 cannot be obtained. In order to further secure the effects of each example, the lower limit of inequality (14) may be changed to 0.55, 0.60, 0.65, 0.70, 0.75, 0.80, 0.85 or 0.90. The upper limit of inequality (14) may be changed to 1.45, 1.40, 1.35, 1.30, 1.25, 1.20, 1.15 or 1.10.

The phase modulation of the uneven elements in the areas A1 and A2 may monotonically increase or decrease along the radial direction of the substrate within the annulus section. In a case where the phase modulation discretely increases or decreases, the uneven element width is to change relatively significantly, and the effect of suppressing the aspect ratio cannot be obtained. In order to exhibit a light condensing effect when a plane wave enters the optical element according to each example in the thickness direction of the substrate, the phase modulation within the annulus section shows that the phase delay monotonically decreases in the radial direction from the inside of the substrate to an outer circumference portion. In addition, in a case where the optical element 100 according to each example has a light diverging effect, the phase modulation within the annulus section shows that a phase delay monotonically increases in the radial direction from the inside of the substrate to the outer circumferential portion.

In each example, the following inequality (15) may be satisfied:

$$0. \leq H 2 / t \leq 0.10 \qquad ( 15 )$$

where t is a thickness of the substrate 1 in the optical axis direction.

Inequality (15) relates to the shape of the optical element. The height H2 of the uneven element in the area A2 and the thickness t of the substrate are both numerical values indicating length, and are larger than 0. Therefore, the value never becomes lower than the lower limit of inequality (15). In a case where the value becomes higher than the upper limit of inequality (15), the substrate becomes relatively thin, and deformation due to its own weight cannot be suppressed when the substrate is held by a holder, or the substrate may deform during manufacturing using lithography technology. In order to further secure the effects of each example, the lower limit of inequality (15) may be changed to 0.000001, 0.000005, 0.00001, or 0.0001. The upper limit of inequality (15) may be changed to 0.08, 0.06, 0.04, 0.02, 0.01, 0.008, 0.006, or 0.004.

A detailed description will now be given of the optical element according to each example.

An optical element according to Example 1 has an uneven structure that includes a substrate made of synthetic quartz and having a thickness of 0.775 mm, and a convex cylindrical element made of Si₃N₄. The uneven elements in the areas A1 and A2 are arranged for each square segment having a side of 240 nm, and have heights H1 and H2 of 880 nm and 440 nm, respectively. The uneven structure has an effective diameter of φ4.0 mm, 105 annulus sections in which a phase difference of 2π (with a diffraction order of 1) periodically repeats at a wavelength of 500 nm, and a focal length of 40.0 mm. A position where a normalized phase is 0.488 is set to the boundary between the areas A1 and A2 in the annulus section, and the maximum values of the aspect ratios in the areas A1 and A2 are 6.20 and 9.80, respectively. Therefore, the aspect ratio can be suppressed in comparison with the maximum aspect ratio of 20.2 in reference example 1 in which the heights of the uneven elements are equal in all the areas.

An optical element according to Example 2 has an uneven structure that includes a substrate made of synthetic quartz and having a thickness of 0.775 mm, and a convex cylindrical element made of Si₃N₄. The uneven elements in the areas A1 and A2 are arranged for each square segment having a side of 300 nm, and have heights H1 and H2 of 1000 nm and 500 nm, respectively. The uneven structure has an effective diameter of φ2.5 mm, 67 annulus sections in which a phase difference of 2π (with a diffraction order of 1) repeats periodically at a wavelength of 587.56 nm, and a focal length of 20.0 mm. A position where a normalized phase is 0.510 is set to the boundary between the areas A1 and A2 in the annulus section, and the maximum values of the aspect ratios in the areas A1 and A2 are 5.55 and 9.18, respectively. Therefore, the aspect ratio can be suppressed in comparison with the maximum aspect ratio of 18.9 in reference example 2 in which the heights of the uneven elements are equal in all the areas.

An optical element according to Example 3 has an uneven structure that includes a substrate made of synthetic quartz and having a thickness of 0.775 mm, and a convex cylindrical element made of Si₃N₄. The uneven elements in the areas A1 and A2 are arranged for each square segment having a side of 320 nm, and have heights H1 and H2 of 1600 nm and 800 nm, respectively. The uneven structure has an effective diameter of φ2.5 mm, 72 annulus sections in which a phase difference of 4π (with a diffraction order of 2) is periodically repeated at a wavelength of 546.07 nm, and a focal length of 10.0 mm. A position where a normalized phase is 0.498 is set to the boundary between the areas A1 and A2 in the annulus section, and the maximum values of the aspect ratios in the areas A1 and A2 are 8.57 and 15.06, respectively. Therefore, the aspect ratio can be suppressed in comparison with the maximum aspect ratio of 31.3 in reference example 3 in which the heights of the uneven elements are equal in all the areas.

An optical element according to Example 4 has an uneven structure that includes a substrate made of synthetic quartz and having a thickness of 0.775 mm, a convex cylindrical element made of TiO₂, and an offset layer having a uniform thickness. The uneven elements in the areas A1 and A2 are arranged for each square segment having a side of 240 nm, and have heights H1 and H2 of 600 nm and 300 nm, respectively. The uneven structure has an effective diameter of φ6.0 mm, 90 annulus sections in which a phase difference of 2π (with a diffraction order of 1) periodically repeats at a wavelength of 500 nm, and a focal length of 100.0 mm. A position where a normalized phase is 0.475 is set to the boundary between the areas A1 and A2 in the annulus section, and the maximum values of the aspect ratios in the areas A1 and A2 are 4.25 and 5.83, respectively. Therefore, the aspect ratio can be suppressed in comparison with the maximum aspect ratio of 11.9 in reference example 4 in which the heights of the uneven elements are equal in all the areas.

An optical element according to Example 5 has an uneven structure that includes a substrate made of synthetic quartz and having a thickness of 2.0 mm, a convex cylindrical element made of Al₂O₃, and an offset layer having a uniform thickness. The uneven elements in the areas A1 and A2 are arranged for each square segment having a side of 300 nm, and have heights H1 and H2 of 1400 nm and 700 nm, respectively. The uneven structure has an effective diameter of 46.0 mm, 223 annulus sections in which a phase difference of 2π (with a diffraction order of 1) is periodically repeated at a wavelength of 486.1 nm, and a focal length of 41.7 mm. A position where a normalized phase is 0.490 is set to the boundary between the areas A1 and A2 in the annulus section, and the maximum values of the aspect ratios in the areas A1 and A2 are 8.08 and 12.74, respectively. Therefore, the aspect ratio can be suppressed in comparison with the maximum aspect ratio of 26.5 in reference example 5 in which the heights of the uneven elements are equal in all the areas.

Optical elements according to Examples 6 to 10 have specifications similar to those of the optical elements according to Examples 1 to 5, respectively, except that the height of the uneven element in the area A2 is different.

The height of the uneven element in the area A2 of the optical element according to Example 6 is 352 nm. A position where a normalized phase is 0.390 is set to the boundary between the areas A1 and A2 in the annulus section, and the maximum values of the aspect ratios in the areas A1 and A2 are 6.77 and 7.78, respectively.

The height of the uneven elements in the area A2 of the optical element according to Example 7 is 400 nm. A position where a normalized phase is 0.250 is set to the boundary between the areas A1 and A2 in the annulus section, and the maximum values of the aspect ratios in the areas A1 and A2 are 7.30 and 7.29, respectively.

The height of the uneven element in the area A2 of the optical element according to Example 8 is 640 nm. A position where a normalized phase is 0.375 is set to the boundary between the areas A1 and A2 in the annulus section, and the maximum values of the aspect ratio in the areas A1 and A2 are 9.56 and 11.84, respectively.

The height of the uneven element in the area A2 of the optical element according to Example 9 is 240 nm. A position where a normalized phase is 0.68 is set to the boundary between the areas A1 and A2 in the annulus section, and the maximum values of the aspect ratios in the areas A1 and A2 are 4.67 and 4.64, respectively.

The height of the uneven element in the area A2 of the optical element according to Example 10 is 560 nm. A position where a normalized phase is 0.389 is set to the boundary between the areas A1 and A2 in the annulus section, and the maximum values of the aspect ratios in the areas A1 and A2 are 8.94 and 10.10, respectively.

The optical elements according to Examples 11 to 15 have the same specifications similar to those of the optical elements according to Examples 1 to 5, except that the height H2 of the uneven element in the area A2 is different.

The height H2 of the uneven elements in the area A2 of the optical element according to Example 11 is 528 nm. A position where a normalized phase is 0.590 is set to the boundary between the areas A1 and A2 in the annulus section, and the maximum values of the aspect ratios in the areas A1 and A2 are 5.73 and 11.83, respectively.

The height H2 of the uneven element in the area A2 of the optical element according to Example 12 is 600 nm. A position where a normalized phase is 0.60 is set to the boundary between the areas A1 and A2 in the annulus section, and the maximum values of the aspect ratios in the areas A1 and A2 are 5.22 and 11.08, respectively.

The height H2 of the uneven element in the area A2 of the optical element according to Example 13 is 960 nm. A position where a normalized phase is 0.587 is set to the boundary between the areas A1 and A2 in the annulus section, and the maximum values of the aspect ratios in the areas A1 and A2 are 8.00 and 18.27, respectively.

The height H2 of the uneven element in the area A2 of the optical element according to Example 14 is 360 nm. A position where a normalized phase is 0.56 is set to the boundary between the areas A1 and A2 in the annulus section, and the maximum values of the aspect ratios in the areas A1 and A2 are 4.00 and 7.04, respectively.

The height H2 of the uneven element in the area A2 of the optical element according to Example 15 is 840 nm. A position where a normalized phase is 0.591 is set to the boundary between the areas A1 and A2 in the annulus section, and the maximum values of the aspect ratios in the areas A1 and A2 are 7.42 and 15.41, respectively.

An optical element according to Example 16 has a specification similar to that of the optical element according to Example 1, except that the height H1 of the uneven element in the area A1 is different.

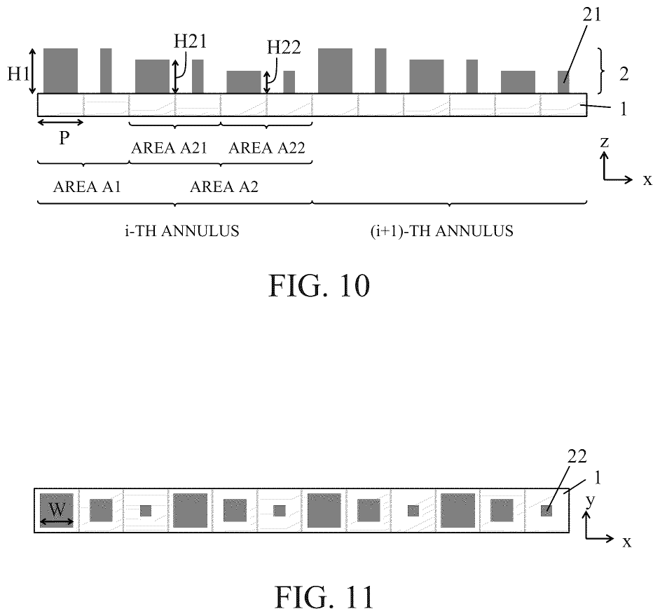

FIG. 10 is a configuration diagram of the optical element according to Example 16. As illustrated in FIG. 10, the area A2 of the optical element according to Example 16 has an area A21 in which the height of the uneven element is H21 and an area A22 in which the height of the uneven element is H22. The height of the uneven element in the area A1 is 880 nm, and the heights of the uneven elements in the area A2 are 528 nm and 352 nm, respectively. The position where the uneven elements in the area A2 in the annulus section have different heights is a position at which a normalized phase of 0.28, and the boundary between the areas A1 and A2 is a position at which the normalized phase of 0.59. The maximum value of the aspect ratio in the area A1 is 5.74, and the maximum values of the aspect ratios in the area A2 are 3.74 and 7.07.

An optical element according to Example 17 has an uneven structure that includes a substrate made of synthetic quartz and convex quadrangular prism elements made of Si₃N₄.

FIG. 11 is a configuration diagram (top view) of the optical element according to Example 17. The quadrangular prism elements in the areas A1 and A2 are arranged for each square segment having a side of 240 nm, and have heights H1 and H2 of 800 nm and 400 nm, respectively. The uneven structure has an effective diameter and the number of annulus sections, which are similar to those of the optical element according to Example 1. The width of the uneven element in the quadrangular prism element can use the length of the side of the quadrangular prism in the radial direction of the optical element as illustrated in FIG. 11. A position where a normalized phase is 0.478 is set to the boundary between the areas A1 and A2 in the annulus section, and the maximum values of the aspect ratios in the areas A1 and A2 are 6.09 and 7.26, respectively. Therefore, the aspect ratio can be suppressed in comparison with the maximum aspect ratio of 15.3 in reference example 6 in which the heights of the uneven elements are equal in all the areas.

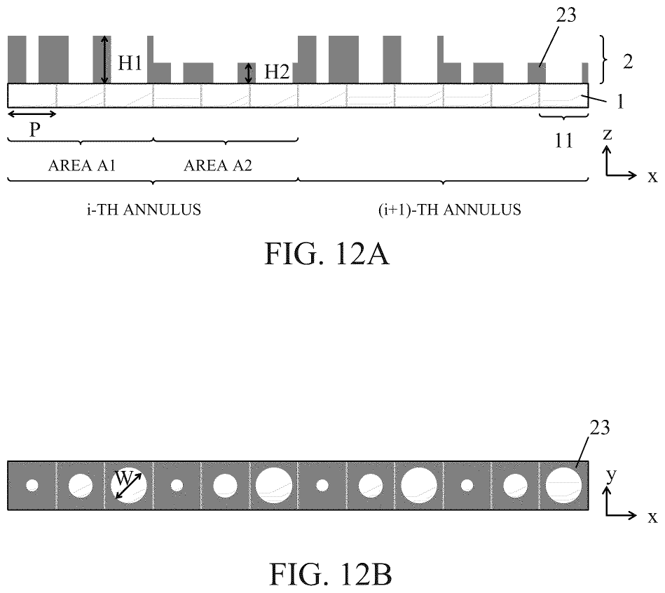

The optical element according to Example 18 has an uneven structure that includes a substrate made of synthetic quartz and concave cylindrical elements made of Si₃N₄. FIGS. 12A and 12B are configuration diagrams of the optical element according to Example 18. FIG. 12A is a sectional view, and FIG. 12B is a top view. The quadrangular prism elements in the areas A1 and A2 are arranged for each square segment having a side of 240 nm, and have heights of 800 nm and 560 nm, respectively. The uneven structure has an effective diameter and the number of annulus sections, which are similar to those of the optical element according to Example 1. The minimum width of the uneven elements in the uneven element can use a value obtained by subtracting the maximum width of the concave elements from the repetitive period P. That is, the minimum widths of the uneven elements in the areas A1 and A2 in Example 18 are 60.9 nm and 42.8 nm, respectively. A position where a normalized phase is 0.478 is set to the boundary between the areas A1 and A2 in the annulus section, and the maximum values of the aspect ratios in the areas A1 and A2 are 13.13 and 13.09, respectively. Therefore, the aspect ratio can be suppressed in comparison with the maximum aspect ratio of 37.9 in reference example 7 in which the heights of the uneven elements are equal in all the areas.

Numerical examples 1 to 18 corresponding to the optical elements according to the Examples 1 to 18 will be illustrated below. A phase φ, which indicates the light condensing and diverging effects of the uneven structure, is expressed as follows:

$$ϕ ( h ) = ( 2 π \frac{m}{{λ}_{0}} ) {\sum }_{k} {C}_{2 k} {h}^{2 k}$$

where h is a height from the optical axis in a direction orthogonal to the optical axis (radial direction), m is a diffraction order of diffracted light, λ0 is a reference wavelength, and Ck (k=1, 2, 3 . . . ) is a phase coefficient of each order.

nd, ng, nC, nF, and n500 are refractive indices for the d-line (587.6 nm), g-line (435.8 nm), F-line (486.1 nm), and C-line (656.3 nm), and a wavelength of 500 nm. W1 [nm] and W2 [nm] are widths of the uneven elements in the areas A1 and A2, respectively, and Wref [nm] is a width of the uneven element in the comparative example.

NUMERICAL EXAMPLE 1

| NORMALIZED PHASE | W1 | W2 | Wref |
|---|---|---|---|
| 0.00 | | 44.89 | 43.48 |
| 0.05 | | 82.64 | 66.44 |
| 0.10 | | 104.37 | 82.23 |
| 0.15 | | 120.82 | 94.19 |
| 0.20 | | 134.31 | 104.04 |
| 0.25 | | 146.06 | 112.59 |
| 0.30 | | 157.03 | 120.22 |
| 0.35 | | 167.49 | 127.12 |
| 0.40 | | 177.46 | 133.44 |
| 0.45 | | 187.60 | 139.34 |
| 0.50 | 143.42 | | 144.96 |
| 0.55 | 148.92 | | 150.41 |
| 0.60 | 154.29 | | 155.75 |
| 0.65 | 159.56 | | 161.01 |
| 0.70 | 164.74 | | 166.16 |
| 0.75 | 169.80 | | 171.21 |
| 0.80 | 174.79 | | 176.18 |
| 0.85 | 179.78 | | 181.18 |
| 0.90 | 184.89 | | 186.30 |
| 0.95 | 190.12 | | 191.56 |
| 1.00 | 195.11 | | 196.52 |

NUMERICAL EXAMPLE 2

| NORMALIZED PHASE | W1 | W2 | Wref |
|---|---|---|---|
| 0.00 | | 54.47 | 52.75 |
| 0.05 | | 102.86 | 82.62 |
| 0.10 | | 129.99 | 102.46 |
| 0.15 | | 150.50 | 117.25 |
| 0.20 | | 167.33 | 129.44 |
| 0.25 | | 182.02 | 140.09 |
| 0.30 | | 195.87 | 149.64 |
| 0.35 | | 209.22 | 158.28 |
| 0.40 | | 222.10 | 166.18 |
| 0.45 | | 235.47 | 173.54 |
| 0.50 | | 248.19 | 180.55 |
| 0.55 | 185.74 | | 187.39 |
| 0.60 | 192.51 | | 194.14 |
| 0.65 | 199.20 | | 200.82 |
| 0.70 | 205.78 | | 207.39 |
| 0.75 | 212.24 | | 213.84 |
| 0.80 | 218.63 | | 220.22 |
| 0.85 | 225.09 | | 226.70 |
| 0.90 | 231.81 | | 233.46 |
| 0.95 | 238.81 | | 240.52 |
| 1.00 | 245.53 | | 247.25 |

NUMERICAL EXAMPLE 3

| NORMALIZED PHASE | W1 | W2 | Wref |
|---|---|---|---|
| 0.00 | | 53.13 | 51.19 |
| 0.05 | | 107.92 | 87.82 |
| 0.10 | | 137.29 | 109.52 |
| 0.15 | | 158.02 | 124.50 |
| 0.20 | | 174.48 | 136.56 |
| 0.25 | | 188.78 | 147.21 |
| 0.30 | | 202.51 | 156.88 |
| 0.35 | | 216.34 | 165.67 |
| 0.40 | | 230.67 | 173.71 |
| 0.45 | | 247.16 | 181.22 |
| 0.50 | 187.06 | | 188.47 |
| 0.55 | 194.30 | | 195.70 |
| 0.60 | 201.62 | | 203.04 |
| 0.65 | 209.05 | | 210.50 |
| 0.70 | 216.53 | | 218.01 |
| 0.75 | 224.02 | | 225.53 |
| 0.80 | 231.60 | | 233.14 |
| 0.85 | 239.52 | | 241.13 |
| 0.90 | 248.13 | | 249.85 |
| 0.95 | 257.54 | | 259.40 |
| 1.00 | 266.87 | | 268.81 |

NUMERICAL EXAMPLE 4

| NORMALIZED PHASE | W1 | W2 | Wref |
|---|---|---|---|
| 0.00 | | 51.43 | 50.31 |
| 0.05 | | 89.10 | 74.88 |
| 0.10 | | 109.50 | 88.30 |
| 0.15 | | 123.74 | 97.79 |
| 0.20 | | 135.37 | 106.21 |
| 0.25 | | 145.67 | 114.22 |
| 0.30 | | 155.31 | 121.71 |
| 0.35 | | 164.68 | 128.46 |
| 0.40 | | 174.06 | 134.45 |
| 0.45 | | 183.71 | 139.84 |
| 0.50 | 143.71 | | 144.91 |
| 0.55 | 148.72 | | 149.87 |
| 0.60 | 153.67 | | 154.80 |
| 0.65 | 158.50 | | 159.61 |
| 0.70 | 163.07 | | 164.14 |
| 0.75 | 167.27 | | 168.30 |
| 0.80 | 171.20 | | 172.18 |
| 0.85 | 175.18 | | 176.16 |
| 0.90 | 179.64 | | 180.66 |
| 0.95 | 184.59 | | 185.69 |
| 1.00 | 188.57 | | 189.69 |

NUMERICAL EXAMPLE 5

| NORMALIZED PHASE | W1 | W2 | Wref |
|---|---|---|---|
| 0.00 | | 54.95 | 52.81 |
| 0.05 | | 98.35 | 79.50 |
| 0.10 | | 124.57 | 97.73 |
| 0.15 | | 145.10 | 111.77 |
| 0.20 | | 162.45 | 123.67 |
| 0.25 | | 177.90 | 134.35 |
| 0.30 | | 192.49 | 144.13 |
| 0.35 | | 206.58 | 153.16 |
| 0.40 | | 220.21 | 161.57 |
| 0.45 | | 233.98 | 169.50 |
| 0.50 | 174.74 | | 177.11 |
| 0.55 | 182.23 | | 184.54 |
| 0.60 | 189.58 | | 191.85 |
| 0.65 | 196.81 | | 199.06 |
| 0.70 | 203.91 | | 206.13 |
| 0.75 | 210.86 | | 213.04 |
| 0.80 | 217.67 | | 219.82 |
| 0.85 | 224.46 | | 226.60 |
| 0.90 | 231.36 | | 233.51 |
| 0.95 | 238.38 | | 240.55 |
| 1.00 | 245.05 | | 247.19 |

NUMERICAL EXAMPLE 6

| NORMALIZED PHASE | W1 | W2 | Wref |
|---|---|---|---|
| 0.00 | | 45.24 | 43.48 |
| 0.05 | | 88.68 | 66.44 |
| 0.10 | | 112.41 | 82.23 |
| 0.15 | | 130.69 | 94.19 |
| 0.20 | | 145.81 | 104.04 |
| 0.25 | | 159.65 | 112.59 |
| 0.30 | | 172.50 | 120.22 |
| 0.35 | | 184.90 | 127.12 |
| 0.40 | 131.30 | | 133.44 |
| 0.45 | 137.34 | | 139.34 |
| 0.50 | 143.05 | | 144.96 |
| 0.55 | 148.55 | | 150.41 |
| 0.60 | 153.93 | | 155.75 |
| 0.65 | 159.21 | | 161.01 |
| 0.70 | 164.39 | | 166.16 |
| 0.75 | 169.46 | | 171.21 |
| 0.80 | 174.45 | | 176.18 |
| 0.85 | 179.45 | | 181.18 |
| 0.90 | 184.55 | | 186.30 |
| 0.95 | 189.77 | | 191.56 |
| 1.00 | 194.76 | | 196.52 |

NUMERICAL EXAMPLE 7

| NORMALIZED PHASE | W1 | W2 | Wref |
|---|---|---|---|
| 0.00 | | 54.90 | 52.75 |
| 0.05 | | 110.82 | 82.62 |
| 0.10 | | 140.39 | 102.46 |
| 0.15 | | 163.10 | 117.25 |
| 0.20 | | 181.90 | 129.44 |
| 0.25 | 136.97 | 199.30 | 140.09 |
| 0.30 | 146.81 | | 149.64 |
| 0.35 | 155.69 | | 158.28 |
| 0.40 | 163.79 | | 166.18 |
| 0.45 | 171.30 | | 173.54 |
| 0.50 | 178.42 | | 180.55 |
| 0.55 | 185.32 | | 187.39 |
| 0.60 | 192.10 | | 194.14 |
| 0.65 | 198.79 | | 200.82 |
| 0.70 | 205.37 | | 207.39 |
| 0.75 | 211.84 | | 213.84 |
| 0.80 | 218.23 | | 220.22 |
| 0.85 | 224.69 | | 226.70 |
| 0.90 | 231.40 | | 233.46 |
| 0.95 | 238.38 | | 240.52 |
| 1.00 | 245.10 | | 247.25 |

NUMERICAL EXAMPLE 8

| NORMALIZED PHASE | W1 | W2 | Wref |
|---|---|---|---|
| 0.00 | | 54.04 | 51.19 |
| 0.05 | | 110.82 | 87.82 |
| 0.10 | | 149.35 | 109.52 |
| 0.15 | | 168.79 | 124.50 |
| 0.20 | | 185.56 | 136.56 |
| 0.25 | | 202.57 | 147.21 |
| 0.30 | | 223.41 | 156.88 |
| 0.35 | | 251.43 | 165.67 |
| 0.40 | 171.41 | | 173.71 |
| 0.45 | 179.06 | | 181.22 |
| 0.50 | 186.38 | | 188.47 |
| 0.55 | 193.63 | | 195.70 |
| 0.60 | 200.95 | | 203.04 |
| 0.65 | 208.36 | | 210.50 |
| 0.70 | 215.83 | | 218.01 |
| 0.75 | 223.31 | | 225.53 |
| 0.80 | 230.87 | | 233.14 |
| 0.85 | 238.76 | | 241.13 |
| 0.90 | 247.31 | | 249.85 |
| 0.95 | 256.65 | | 259.40 |
| 1.00 | 265.96 | | 268.81 |

NUMERICAL EXAMPLE 9

| NORMALIZED PHASE | W1 | W2 | Wref |
|---|---|---|---|
| 0.00 | | 51.76 | 50.31 |
| 0.05 | | 95.26 | 74.88 |
| 0.10 | | 117.82 | 88.30 |
| 0.15 | | 134.20 | 97.79 |
| 0.20 | | 147.73 | 106.21 |
| 0.25 | | 160.17 | 114.22 |
| 0.30 | | 171.97 | 121.71 |
| 0.35 | | 184.15 | 128.46 |
| 0.40 | 132.61 | | 134.45 |
| 0.45 | 138.17 | | 139.84 |
| 0.50 | 143.35 | | 144.91 |
| 0.55 | 148.37 | | 149.87 |
| 0.60 | 153.33 | | 154.80 |
| 0.65 | 158.17 | | 159.61 |
| 0.70 | 162.75 | | 164.14 |
| 0.75 | 166.97 | | 168.30 |
| 0.80 | 170.91 | | 172.18 |
| 0.85 | 174.89 | | 176.16 |
| 0.90 | 179.33 | | 180.66 |
| 0.95 | 184.26 | | 185.69 |
| 1.00 | 188.24 | | 189.69 |

NUMERICAL EXAMPLE 10

| NORMALIZED PHASE | W1 | W2 | Wref |
|---|---|---|---|
| 0.00 | | 55.45 | 52.81 |
| 0.05 | | 105.82 | 79.50 |
| 0.10 | | 134.78 | 97.73 |
| 0.15 | | 157.72 | 111.77 |
| 0.20 | | 177.46 | 123.67 |
| 0.25 | | 195.98 | 134.35 |
| 0.30 | | 213.68 | 144.13 |
| 0.35 | | 230.97 | 153.16 |
| 0.40 | 158.35 | | 161.57 |
| 0.45 | 166.45 | | 169.50 |
| 0.50 | 174.19 | | 177.11 |
| 0.55 | 181.69 | | 184.54 |
| 0.60 | 189.05 | | 191.85 |
| 0.65 | 196.29 | | 199.06 |
| 0.70 | 203.40 | | 206.13 |
| 0.75 | 210.35 | | 213.04 |
| 0.80 | 217.17 | | 219.82 |
| 0.85 | 223.96 | | 226.60 |
| 0.90 | 230.86 | | 233.51 |
| 0.95 | 237.87 | | 240.55 |
| 1.00 | 244.55 | | 247.19 |

NUMERICAL EXAMPLE 11

| NORMALIZED PHASE | W1 | W2 | Wref |
|---|---|---|---|
| 0.00 | | 44.64 | 43.48 |
| 0.05 | | 78.59 | 66.44 |
| 0.10 | | 97.93 | 82.23 |
| 0.15 | | 112.67 | 94.19 |
| 0.20 | | 125.08 | 104.04 |
| 0.25 | | 135.77 | 112.59 |
| 0.30 | | 145.38 | 120.22 |
| 0.35 | | 154.52 | 127.12 |
| 0.40 | | 163.37 | 133.44 |
| 0.45 | | 171.79 | 139.34 |
| 0.50 | | 180.00 | 144.96 |
| 0.55 | | 188.62 | 150.41 |
| 0.60 | 154.56 | | 155.75 |
| 0.65 | 159.83 | | 161.01 |
| 0.70 | 165.00 | | 166.16 |
| 0.75 | 170.06 | | 171.21 |
| 0.80 | 175.04 | | 176.18 |
| 0.85 | 180.04 | | 181.18 |
| 0.90 | 185.15 | | 186.30 |
| 0.95 | 190.38 | | 191.56 |
| 1.00 | 195.36 | | 196.52 |

NUMERICAL EXAMPLE 12

| NORMALIZED PHASE | W1 | W2 | Wref |
|---|---|---|---|
| 0.00 | | 54.13 | 52.75 |
| 0.05 | | 97.99 | 82.62 |
| 0.10 | | 122.34 | 102.46 |
| 0.15 | | 140.66 | 117.25 |
| 0.20 | | 156.06 | 129.44 |
| 0.25 | | 169.31 | 140.09 |
| 0.30 | | 181.28 | 149.64 |
| 0.35 | | 192.76 | 158.28 |
| 0.40 | | 203.97 | 166.18 |
| 0.45 | | 214.76 | 173.54 |
| 0.50 | | 225.37 | 180.55 |
| 0.55 | | 236.64 | 187.39 |
| 0.60 | 192.83 | | 194.14 |
| 0.65 | 199.52 | | 200.82 |
| 0.70 | 206.10 | | 207.39 |
| 0.75 | 212.56 | | 213.84 |
| 0.80 | 218.94 | | 220.22 |
| 0.85 | 225.41 | | 226.70 |
| 0.90 | 232.14 | | 233.46 |
| 0.95 | 239.15 | | 240.52 |
| 1.00 | 245.87 | | 247.25 |

NUMERICAL EXAMPLE 13

| NORMALIZED PHASE | W1 | W2 | Wref |
|---|---|---|---|
| 0.00 | | 52.55 | 51.19 |
| 0.05 | | 103.72 | 87.82 |
| 0.10 | | 129.39 | 109.52 |
| 0.15 | | 147.85 | 124.50 |
| 0.20 | | 163.32 | 136.56 |
| 0.25 | | 176.76 | 147.21 |
| 0.30 | | 189.18 | 156.88 |
| 0.35 | | 201.56 | 165.67 |
| 0.40 | | 214.26 | 173.71 |
| 0.45 | | 227.22 | 181.22 |
| 0.50 | | 240.83 | 188.47 |
| 0.55 | | 256.07 | 195.70 |
| 0.60 | 202.04 | | 203.04 |
| 0.65 | 209.48 | | 210.50 |
| 0.70 | 216.97 | | 218.01 |
| 0.75 | 224.47 | | 225.53 |
| 0.80 | 232.06 | | 233.14 |
| 0.85 | 240.00 | | 241.13 |
| 0.90 | 248.64 | | 249.85 |
| 0.95 | 258.09 | | 259.40 |
| 1.00 | 267.45 | | 268.81 |

NUMERICAL EXAMPLE 14

| NORMALIZED PHASE | W1 | W2 | Wref |
|---|---|---|---|
| 0.00 | | 51.11 | 50.31 |
| 0.05 | | 84.12 | 74.88 |
| 0.10 | | 102.86 | 88.30 |
| 0.15 | | 116.25 | 97.79 |
| 0.20 | | 127.12 | 106.21 |
| 0.25 | | 136.53 | 114.22 |
| 0.30 | | 145.12 | 121.71 |
| 0.35 | | 153.35 | 128.46 |
| 0.40 | | 161.44 | 134.45 |
| 0.45 | | 169.51 | 139.84 |
| 0.50 | | 177.91 | 144.91 |
| 0.55 | | 187.01 | 149.87 |
| 0.60 | 153.99 | | 154.80 |
| 0.65 | 158.82 | | 159.61 |
| 0.70 | 163.37 | | 164.14 |
| 0.75 | 167.57 | | 168.30 |
| 0.80 | 171.48 | | 172.18 |
| 0.85 | 175.46 | | 176.16 |
| 0.90 | 179.93 | | 180.66 |
| 0.95 | 184.90 | | 185.69 |
| 1.00 | 188.89 | | 189.69 |

NUMERICAL EXAMPLE 15

| NORMALIZED PHASE | W1 | W2 | Wref |
|---|---|---|---|
| 0.00 | | 54.52 | 52.81 |
| 0.05 | | 92.49 | 79.50 |
| 0.10 | | 115.89 | 97.73 |
| 0.15 | | 134.45 | 111.77 |
| 0.20 | | 150.51 | 123.67 |
| 0.25 | | 164.72 | 134.35 |
| 0.30 | | 177.73 | 144.13 |
| 0.35 | | 190.13 | 153.16 |
| 0.40 | | 202.13 | 161.57 |
| 0.45 | | 213.63 | 169.50 |
| 0.50 | | 224.83 | 177.11 |
| 0.55 | | 236.28 | 184.54 |
| 0.60 | 190.04 | | 191.85 |
| 0.65 | 197.27 | | 199.06 |
| 0.70 | 204.37 | | 206.13 |
| 0.75 | 211.30 | | 213.04 |
| 0.80 | 218.11 | | 219.82 |
| 0.85 | 224.90 | | 226.60 |
| 0.90 | 231.80 | | 233.51 |
| 0.95 | 238.82 | | 240.55 |
| 1.00 | 245.48 | | 247.19 |

NUMERICAL EXAMPLE 16

| NORMALIZED PHASE | W1 | W21 | W22 | Wref |
|---|---|---|---|---|
| 0.00 | | | 49.77 | 43.48 |
| 0.05 | | | 90.56 | 66.44 |
| 0.10 | | | 113.78 | 82.23 |
| 0.15 | | | 131.79 | 94.19 |
| 0.20 | | | 146.76 | 104.04 |
| 0.25 | | | 160.55 | 112.59 |
| 0.30 | | 144.91 | | 120.22 |
| 0.35 | | 154.07 | | 127.12 |
| 0.40 | | 162.93 | | 133.44 |
| 0.45 | | 171.37 | | 139.34 |
| 0.50 | | 179.58 | | 144.96 |
| 0.55 | | 188.18 | | 150.41 |
| 0.60 | 154.29 | | | 155.75 |
| 0.65 | 159.56 | | | 161.01 |
| 0.70 | 164.74 | | | 166.16 |
| 0.75 | 169.80 | | | 171.21 |
| 0.80 | 174.79 | | | 176.18 |
| 0.85 | 179.78 | | | 181.18 |
| 0.90 | 184.89 | | | 186.30 |
| 0.95 | 190.12 | | | 191.56 |
| 1.00 | 195.11 | | | 196.52 |

NUMERICAL EXAMPLE 17

| NORMALIZED PHASE | W1 | W2 | Wref |
|---|---|---|---|
| 0.00 | | 55.06 | 52.45 |
| 0.05 | | 82.23 | 68.80 |
| 0.10 | | 100.14 | 80.91 |
| 0.15 | | 114.41 | 90.64 |
| 0.20 | | 126.69 | 98.96 |
| 0.25 | | 137.79 | 106.39 |
| 0.30 | | 148.30 | 113.16 |
| 0.35 | | 158.53 | 119.43 |
| 0.40 | | 168.64 | 125.30 |
| 0.45 | | 179.01 | 130.86 |
| 0.50 | 133.64 | | 136.22 |
| 0.55 | 138.92 | | 141.43 |
| 0.60 | 144.08 | | 146.56 |
| 0.65 | 149.18 | | 151.63 |
| 0.70 | 154.22 | | 156.66 |
| 0.75 | 159.23 | | 161.67 |
| 0.80 | 164.23 | | 166.68 |
| 0.85 | 169.27 | | 171.74 |
| 0.90 | 174.41 | | 176.93 |
| 0.95 | 179.67 | | 182.25 |
| 1.00 | 184.94 | | 187.55 |

NUMERICAL EXAMPLE 18

| NORMALIZED PHASE | W1 | W2 | Wref |
|---|---|---|---|
| 0.00 | | 197.21 | 218.87 |
| 0.05 | | 189.84 | 215.53 |
| 0.10 | | 181.74 | 211.28 |
| 0.15 | | 172.76 | 206.91 |
| 0.20 | | 162.88 | 202.52 |
| 0.25 | | 151.85 | 197.95 |
| 0.30 | | 139.35 | 193.04 |
| 0.35 | | 124.72 | 187.69 |
| 0.40 | | 106.23 | 181.85 |
| 0.45 | | 80.47 | 175.54 |
| 0.50 | 172.55 | | 168.72 |
| 0.55 | 165.47 | | 161.34 |
| 0.60 | 157.78 | | 153.30 |
| 0.65 | 149.40 | | 144.50 |
| 0.70 | 140.21 | | 134.81 |
| 0.75 | 130.08 | | 124.07 |
| 0.80 | 118.83 | | 112.03 |
| 0.85 | 106.03 | | 98.04 |
| 0.90 | 90.74 | | 80.67 |
| 0.95 | 70.93 | | 56.93 |
| 1.00 | 42.72 | | 21.13 |

Tables 1 to 3C summarize various numerical values according to each example.

TABLE 1

| | | | | synthetic |
|---|---|---|---|---|
| | Si₃N₄ | TiO₂ | Al₂O₃ | quartz |
| ng | 2.08394 | 2.48181 | 1.63759 | 1.46240 |
| nF | 2.06710 | 2.42034 | 1.63053 | 1.45876 |
| nd | 2.04580 | 2.35281 | 1.62153 | 1.45345 |
| nC | 2.03665 | 2.32645 | 1.61759 | 1.45084 |
| n500 | 2.06337 | 2.40780 | 1.62896 | 1.45790 |

TABLE 2

| | EXAMPLES | | | | |
|---|---|---|---|---|---|
| | 1, 6, 11, | EXAMPLES | EXAMPLES | EXAMPLES | EXAMPLES |
| | 16, 17, AND | 2, 7, AND | 3, 8, AND | 4, 9, AND | 5, 10, AND |
| | 18 | 12 | 13 | 14 | 15 |
| λ0 | 500.0 | 587.6 | 546.1 | 500.0 | 486.1 |
| C2 | −1.249999E−02 | −2.500000E−02 | −5.000000E−02 | −5.000000E−03 | −1.200000E−02 |
| C4 | 3.395631E−04 | 0.000000E+00 | 0.000000E+00 | 0.000000E+00 | 0.000000E+00 |
| C6 | −1.203821E−04 | 0.000000E+00 | 0.000000E+00 | 0.000000E+00 | 0.000000E+00 |
| C8 | 0.000000E+00 | 0.000000E+00 | 0.000000E+00 | 0.000000E+00 | 0.000000E+00 |

TABLE 3A

| | EX. 1 | EX. 2 | EX. 3 | EX. 4 | EX. 5 | EX. 6 | EX. 7 |
|---|---|---|---|---|---|---|---|
| MATERIAL | Si₃N₄ | Si₃N₄ | Si₃N₄ | TiO₂ | Al₂O₃ | Si₃N₄ | Si₃N₄ |
| λ0 [nm] | 500 | 587.56 | 546.07 | 500 | 486.13 | 500 | 587.56 |
| P [nm] | 240 | 300 | 320 | 240 | 300 | 240 | 300 |
| M | 1 | 1 | 2 | 1 | 1 | 1 | 1 |
| H1 [nm] | 880.0 | 1000.0 | 1600.0 | 600.0 | 1400.0 | 880.0 | 1000.0 |
| H2 [nm] | 440.0 | 500.0 | 800.0 | 300.0 | 700.0 | 352.0 | 400.0 |
| NP | 0.488 | 0.510 | 0.498 | 0.475 | 0.490 | 0.390 | 0.250 |
| Wmin1 [nm] | 142.0 | 180.2 | 186.7 | 141.1 | 173.3 | 130.0 | 137.0 |
| Wmax1 [nm] | 195.1 | 245.5 | 266.9 | 188.6 | 245.0 | 194.8 | 245.1 |
| Wmin2 [nm] | 44.9 | 54.5 | 53.1 | 51.4 | 55.0 | 45.2 | 54.9 |
| Wmax2 [nm] | 195.1 | 249.6 | 266.9 | 188.6 | 245.0 | 194.8 | 199.3 |
| ΔH [nm] | 440.0 | 500.0 | 800.0 | 300.0 | 700.0 | 528.0 | 600.0 |
| ΔW1 [nm] | 53.1 | 65.3 | 80.2 | 47.5 | 71.7 | 64.8 | 108.1 |
| ΔW2 [nm] | 150.2 | 195.2 | 213.7 | 137.1 | 190.1 | 149.5 | 144.4 |
| V1min | 0.275 | 0.284 | 0.267 | 0.272 | 0.262 | 0.230 | 0.164 |
| V1max | 0.519 | 0.526 | 0.546 | 0.485 | 0.524 | 0.517 | 0.524 |
| V2min | 0.014 | 0.013 | 0.011 | 0.018 | 0.013 | 0.011 | 0.011 |
| V2max | 0.260 | 0.272 | 0.273 | 0.242 | 0.262 | 0.207 | 0.139 |
| H2/H1 | 0.500 | 0.500 | 0.500 | 0.500 | 0.500 | 0.400 | 0.400 |
| Wmax1/Wmin1 | 1.37 | 1.36 | 1.43 | 1.34 | 1.41 | 1.50 | 1.79 |
| Wmax2/Wmin2 | 4.35 | 4.58 | 5.02 | 3.67 | 4.46 | 4.31 | 3.63 |
| ΔW1/P | 0.221 | 0.218 | 0.251 | 0.198 | 0.239 | 0.270 | 0.360 |
| ΔW2/P | 0.626 | 0.651 | 0.668 | 0.571 | 0.634 | 0.623 | 0.481 |
| ΔW1/ΔW2 | 0.35 | 0.33 | 0.38 | 0.35 | 0.38 | 0.43 | 0.75 |
| V2max/V1min | 0.943 | 0.959 | 1.022 | 0.893 | 1.000 | 0.898 | 0.847 |
| AR1 | 6.20 | 5.55 | 8.57 | 4.25 | 8.08 | 6.77 | 7.30 |
| AR2 | 9.80 | 9.18 | 15.06 | 5.83 | 12.74 | 7.78 | 7.29 |
| AR2/AR1 | 1.58 | 1.65 | 1.76 | 1.37 | 1.58 | 1.15 | 1.00 |
| Wmax2/Wmax1 | 1.000 | 1.017 | 1.000 | 1.000 | 1.000 | 1.000 | 0.813 |
| ΔH/m/λ0 | 0.88 | 0.85 | 0.73 | 0.60 | 1.44 | 1.06 | 1.02 |
| NP/H2 × H1 | 0.975 | 1.020 | 0.995 | 0.949 | 0.981 | 0.974 | 0.625 |

TABLE 3B

| | EX. 8 | EX. 9 | EX. 10 | EX. 11 | EX. 12 | EX. 13 | EX. 14 |
|---|---|---|---|---|---|---|---|
| MATERIAL | Si₃N₄ | TiO₂ | Al₂O₃ | Si₃N₄ | Si₃N₄ | Si₃N₄ | TiO₂ |
| λ0[nm] | 546.07 | 500 | 486.13 | 500 | 587.56 | 546.07 | 500 |
| P[nm] | 320 | 240 | 300 | 240 | 300 | 320 | 240 |
| M | 2 | 1 | 1 | 1 | 1 | 2 | 1 |
| H1[nm] | 1600.0 | 600.0 | 1400.0 | 880.0 | 1000.0 | 1600.0 | 600.0 |
| H2[nm] | 640.0 | 240.0 | 560.0 | 528.0 | 600.0 | 960.0 | 360.0 |
| NP | 0.375 | 0.367 | 0.389 | 0.590 | 0.592 | 0.587 | 0.560 |
| Wmin1[nm] | 167.4 | 128.6 | 156.6 | 153.5 | 191.7 | 200.1 | 150.1 |
| Wmax1[nm] | 266.0 | 188.2 | 244.5 | 195.4 | 245.9 | 267.5 | 188.9 |
| Wmin2[nm] | 54.0 | 51.8 | 55.5 | 44.6 | 54.1 | 52.5 | 51.1 |
| Wmax2[nm] | 263.5 | 188.2 | 244.5 | 195.4 | 245.9 | 267.5 | 188.9 |
| ΔH[nm] | 960.0 | 360.0 | 840.0 | 352.0 | 400.0 | 640.0 | 240.0 |
| ΔW1[nm] | 98.6 | 59.7 | 88.0 | 41.8 | 54.2 | 67.3 | 38.8 |
| ΔW2[nm] | 209.4 | 136.5 | 189.1 | 150.7 | 191.7 | 214.9 | 137.8 |
| V1min | 0.215 | 0.225 | 0.214 | 0.321 | 0.321 | 0.307 | 0.307 |
| V1max | 0.543 | 0.483 | 0.522 | 0.520 | 0.528 | 0.549 | 0.487 |
| V2min | 0.009 | 0.015 | 0.011 | 0.016 | 0.015 | 0.013 | 0.021 |
| V2max | 0.213 | 0.193 | 0.209 | 0.312 | 0.317 | 0.329 | 0.292 |
| H2/H1 | 0.400 | 0.400 | 0.400 | 0.600 | 0.600 | 0.600 | 0.600 |
| Wmax1/Wmin1 | 1.59 | 1.46 | 1.56 | 1.27 | 1.28 | 1.34 | 1.26 |
| Wmax2/Wmin2 | 4.88 | 3.64 | 4.41 | 4.38 | 4.54 | 5.09 | 3.70 |
| ΔW1/P | 0.308 | 0.249 | 0.293 | 0.174 | 0.181 | 0.210 | 0.162 |
| ΔW2/P | 0.654 | 0.569 | 0.630 | 0.628 | 0.639 | 0.672 | 0.574 |
| ΔW1/ΔW2 | 0.47 | 0.44 | 0.47 | 0.28 | 0.28 | 0.31 | 0.28 |
| V2max/V1min | 0.991 | 0.857 | 0.976 | 0.972 | 0.987 | 1.072 | 0.951 |
| AR1 | 9.56 | 4.67 | 8.94 | 5.73 | 5.22 | 8.00 | 4.00 |
| AR2 | 11.84 | 4.64 | 10.10 | 11.83 | 11.08 | 18.27 | 7.04 |
| AR2/AR1 | 1.24 | 0.99 | 1.13 | 2.06 | 2.12 | 2.28 | 1.76 |
| Wmax2/Wmax1 | 0.991 | 1.000 | 1.000 | 1.000 | 1.000 | 1.000 | 1.000 |
| ΔH/m/λ0 | 0.88 | 0.72 | 1.73 | 0.70 | 0.68 | 0.59 | 0.48 |
| NP/H2 × H1 | 0.938 | 0.917 | 0.974 | 0.984 | 0.986 | 0.978 | 0.934 |

TABLE 3C

| | EX. 15 | EX. 16 | | EX. 17 | EX. 18 |
|---|---|---|---|---|---|
| MATERIAL | Al₂O₃ | Si₃N₄ | | Si₃N₄ | Si₃N₄ |
| λ0[nm] | 486.13 | 500 | 500 | 500 | 500 |
| P[nm] | 300 | 240 | 240 | 240 | 240 |
| M | 1 | 1 | 1 | 1 | 1 |
| H1[nm] | 1400.0 | 880.0 | 880.0 | 800.0 | 800.0 |
| H2[nm] | 840.0 | 528.0 | 352.0 | 400.0 | 560.0 |
| NP | 0.591 | 0.590 | 0.280 | 0.478 | 0.450 |
| Wmin1[nm] | 188.8 | 153.3 | 153.3 | 131.3 | 42.7 |
| Wmax1[nm] | 245.5 | 195.1 | 195.1 | 184.9 | 179.1 |
| Wmin2[nm] | 54.5 | 141.1 | 49.8 | 55.1 | 80.5 |
| Wmax2[nm] | 245.5 | 195.0 | 168.4 | 184.9 | 197.2 |
| ΔH[nm] | 560.0 | 352.0 | 528.0 | 400.0 | 240.0 |
| ΔW1[nm] | 56.7 | 41.8 | 41.8 | 53.6 | 136.4 |
| ΔW2[nm] | 191.0 | 53.8 | 118.6 | 129.9 | 116.8 |
| V1min | 0.311 | 0.320 | 0.320 | 0.299 | 0.563 |
| V1max | 0.526 | 0.519 | 0.519 | 0.594 | 0.975 |
| V2min | 0.016 | 0.163 | 0.014 | 0.026 | 0.329 |
| V2max | 0.316 | 0.311 | 0.155 | 0.297 | 0.638 |
| H2/H1 | 0.600 | 0.600 | 0.400 | 0.500 | 0.700 |
| Wmax1/Wmin1 | 1.30 | 1.27 | 1.27 | 1.41 | 4.19 |
| Wmax2/Wmin2 | 4.50 | 1.38 | 3.38 | 3.36 | 2.45 |
| ΔW1/P | 0.189 | 0.174 | 0.174 | 0.224 | 0.568 |
| ΔW2/P | 0.637 | 0.224 | 0.494 | 0.541 | 0.486 |
| ΔW1/ΔW2 | 0.30 | 0.78 | 0.35 | 0.41 | 1.17 |
| V2max/V1min | 1.015 | 0.971 | 0.483 | 0.992 | 1.134 |
| AR1 | 7.42 | 5.74 | 5.74 | 6.09 | 13.13 |
| AR2 | 15.41 | 3.74 | 7.07 | 7.26 | 13.09 |
| AR2/AR1 | 2.08 | 0.65 | 1.23 | 1.19 | 1.00 |
| Wmax2/Wmax1 | 1.000 | 0.999 | 0.863 | 1.000 | 1.101 |
| ΔH/m/λ0 | 1.15 | 0.70 | 1.06 | 0.80 | 0.48 |
| NP/H2 × H1 | 0.985 | 0.984 | 0.700 | 0.957 | 0.643 |

Table 4 illustrates numerical values representing the uneven structures according to comparative examples (reference examples 1 to 7) corresponding to the optical elements according to each example.

TABLE 4

| | REF. | REF | REF. | REF. | REF | REF. | REF. |
|---|---|---|---|---|---|---|---|
| | EX. 1 | EX. 2 | EX. 3 | EX. 4 | EX. 5 | EX. 6 | EX. 7 |
| MINIMUM | 43.5 | 52.8 | 51.2 | 50.3 | 52.8 | 52.5 | 21.1 |
| WIDTH | | | | | | | |
| MAXIMUM | 196.5 | 247.2 | 268.8 | 189.7 | 247.2 | 187.5 | 218.9 |
| WIDTH | | | | | | | |
| MAXIMUM | 20.2 | 19.0 | 31.3 | 11.9 | 26.5 | 15.3 | 37.9 |
| ASPECT | | | | | | | |
| RATIO | | | | | | | |

### Optical System

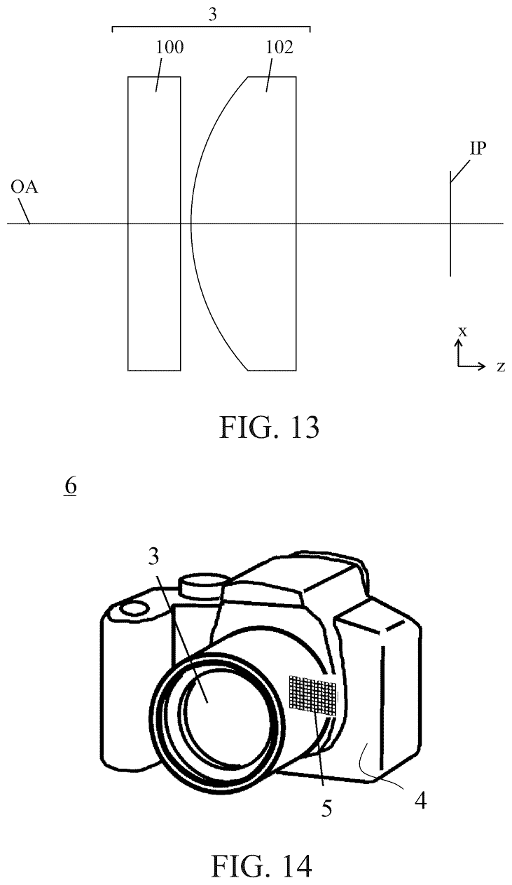

Referring now to FIG. 13, a description will be given of an optical system including the optical element according to any one of the above examples. FIG. 13 explains the optical system including the optical element according to any one of the above examples. In FIG. 13, reference numeral 100 denotes the optical element according to any one of the above examples, reference numeral 102 denotes a lens element, OA denotes an optical axis, IP denotes an image plane, and reference numeral 3 denotes the optical system including the optical element according to any one of the above examples. The lens element includes a lens, a diffractive optical element, a mirror, etc., and the number of lens elements is not limited. The optical element 100 and the lens element 102 are arranged along the optical axis OA to image incident light onto the image plane IP. The uneven element disposed on a surface on the image side of the optical element 100 can provide a light condensing or diverging effect.

### Image Pickup Apparatus

Referring now to FIG. 14, a description will now be given of a digital still camera (image pickup apparatus) using an optical system including the optical elements according to any one of the above examples as an imaging optical system. FIG. 14 explains an image pickup apparatus 6 having the optical system including the optical element according to any one of the above examples. In FIG. 14, reference numeral 4 denotes a camera body, and reference numeral 3 denotes the optical system including the optical element according to any one of the above examples. Reference numeral 5 denotes an image sensor (photoelectric conversion element), such as a CCD sensor or a CMOS sensor, which is built into the camera body 4, receives an optical image formed by the optical system 3, and photoelectrically converts it. The camera body 4 may be a so-called single-lens reflex camera having a quick return mirror, or a so-called mirrorless camera having no quick return mirror. Applying the optical system including the optical element according to each example to an image pickup apparatus such as a digital still camera in this way can provide an image pickup apparatus with a small lens.

Thus, an optical element according to one aspect of the example includes a plurality of annulus sections concentrically arranged. The plurality of annulus sections include a first annulus section that includes a plurality of first structures each having a first height, and a plurality of second structures each having a second height. The plurality of first structures have mutually different widths in a radial direction. The plurality of second structures have mutually different widths in the radial direction. The following inequality is satisfied:

$$0.05 H 2 / H 1 \leq 0.95$$

where H1 is the first height, and H2 is the second height. Thereby, each example can provide an optical element, an optical system, a lens apparatus, and an image pickup apparatus, each of which has a highly stable fine uneven structure.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-117319, which was filed on Jul. 19, 2023, and which is hereby incorporated by reference herein in its entirety.

What is claimed is:

1. An optical element comprising a plurality of annulus sections concentrically arranged,
wherein the plurality of annulus sections include a first annulus section that includes a plurality of first structures each having a first height, and a plurality of second structures each having a second height different from the first height,
wherein the plurality of first structures have mutually different widths in a radial direction, and
wherein the plurality of second structures have mutually different widths in the radial direction.

2. The optical element according to claim 1, wherein the following inequalities are satisfied:
$$0.05 \leq H 2 / H 1 \leq 0.95$$
where H1 is the first height, and H2 is the second height.

3. The optical element according to claim 1, wherein the following inequalities are satisfied:
$$\begin{matrix}1.04 < W max 1 / W min 1 < 20. \\ 1.04 < W max 2 / W min 2 < 20.00\end{matrix}$$
where Wmax1 is a maximum width of the plurality of first structures, Wmax2 is a maximum width of the plurality of second structures, Wmin1 is a minimum width of the plurality of first structures, and Wmin2 is a minimum width of the plurality of second structures.

4. The optical element according to claim 1, wherein the plurality of first structures and the plurality of second structures are arranged at the same period in the radial direction.

5. The optical element according to claim 3, wherein the following inequalities are satisfied:
$$\begin{matrix}0.05 \leq Δ W 1 / P \leq 0.80 \\ 0.15 \leq Δ W 2 / P \leq 0.95\end{matrix}$$
where P is the period, ΔW1 is a difference between a maximum width and a minimum width of the plurality of first structures, and ΔW2 is a difference between a maximum width and a minimum width of the plurality of second structures.

6. The optical element according to claim 1, wherein the following inequality is satisfied:
$$0.05 \leq Δ W 1 / Δ W 2 \leq 1.5$$
where ΔW1 is a difference between a maximum width and a minimum width of the plurality of first structures, and ΔW2 is a difference between a maximum width and a minimum width of the plurality of second structures.

7. The optical element according to claim 4, wherein the following inequality is satisfied:
$$0.7 \leq V 2 max / V 1 min \leq 1.5$$
where V1min is a minimum value of a filling rate of the plurality of first structures, and V2max is a maximum value of the filling rate of the plurality of second structures.

8. The optical element according to claim 1, wherein the following inequalities are satisfied:
$$\begin{matrix}1.5 \leq AR 1 \leq 20.00 \\ 1. 50 \leq AR 2 \leq 20.00\end{matrix}$$
where AR1 is a maximum value of an aspect ratio of the plurality of first structures, and AR2 is a maximum value of the aspect ratio of the plurality of second structures.

9. The optical element according to claim 1, wherein the following inequality is satisfied:
$$0.5 \leq AR 2 / AR 1 \leq 4.00$$
where AR1 is a maximum value of an aspect ratio of the plurality of first structures, and AR2 is a maximum value of the aspect ratio of the plurality of second structures.

10. The optical element according to claim 1, wherein the following inequality is satisfied:
$$0.6 \leq W max 2 / W max 1 \leq 1.2$$
where Wmax1 is a maximum width of the plurality of first structures, and Wmax2 is a maximum width of the plurality of second structures.

11. The optical element according to claim 1, wherein the following inequality is satisfied:
$$0. 25 \leq Δ H / ( m \times λ0 ) \leq 3.$$
where ΔH is a difference between the first height and the second height, m is a designed diffraction order, and λ0 is a design wavelength.

12. The optical element according to claim 1, wherein the following inequality is satisfied:
$$0.15 \leq N P \leq 0.85$$
where NP is a value of a ratio of a minimum phase in a first area in which the plurality of first structures are provided to a maximum phase difference in the first annulus section.

13. The optical element according to claim 1, wherein the following inequality is satisfied:
$$0.5 \leq NP / H 2 \times H 1 \leq 1.5$$
where NP is a value of a ratio of a minimum phase in a first area in which the plurality of first structures are provided to a maximum phase difference in the first annulus section, H1 is the first height, and H2 is the second height.

14. The optical element according to claim 1, wherein a phase modulation amount caused by each of the plurality of first structures and the plurality of second structures monotonically changes in the radial direction of the optical element.

15. The optical element according to claim 1, wherein a phase modulation amount caused by the plurality of first structures is larger than that caused by the plurality of second structures.

16. The optical element according to claim 1, further comprising a substrate, on which the plurality of annulus sections are arranged,
wherein the following inequality is satisfied:
$$0. \leq H 2 / t \leq 0.1$$
where t is a thickness of the substrate, and H2 is the second height.

17. An optical system comprising a plurality of optical elements including the optical element according to claim 1.

18. A lens apparatus comprising:
the optical system according to claim 17; and
a holder configured to hold the optical system.

19. An image pickup apparatus comprising:
the optical system according to claim 17; and
an image sensor configured to receive an image formed by the optical system.
